(19) United States
(12) Patent Application Publication
(10) Pub. No.: US 2014/0355253 A1
(43) Pub. Date: Dec. 4, 2014

(54) Apparatus With Closed Housing And The Isolation And Manufacture Method Thereof

(71) Applicant: OSRAM GmbH, Munich (DE)

(72) Inventors: Longshan YANG, Shenzhen (CN); SiXiong Zeng, Shenzhen (CN); WeiHuang Chen, Shenzhen (CN); Baisong Wang, Shenzhen (CN)

(73) Assignee: OSRAM GmbH, Munich (DE)

(21) Appl. No.: 14/285,558

(22) Filed: May 22, 2014

(30) Foreign Application Priority Data
May 28, 2013 (CN) 201310203191.7

(51) Int. Cl. F21V 31/04; F17C 13/02; F17C 5/06; F21K 99/00; G05D 16/00

(52) U.S. Cl. CPC F21V 31/04; F21K 9/30; G05D 16/00; F17C 5/06; F17C 13/025; F17C 2250/072
USPC 362/101; 137/455; 141/4; 137/154; 137/15.19

(57) ABSTRACT

The present disclosure relates to an apparatus with a closed housing, as well as isolation and manufacture method thereof. The apparatus is arranged in a first medium during operating, and the inside of the apparatus is filled with a second medium the pressure of which is higher than the pressure of the first medium. By means of the apparatus with the closed housing and the isolation and manufacture method according to the embodiments of the present disclosure, at least one of the following objects may be achieved: achieving sufficient sealing with relatively low cost, improving the performance and/or lifetime of the devices contained in the apparatus, and facilitate the maintaining and replacing of the apparatus and the devices contained therein.

### RELATED APPLICATION

This application claims the priority of Chinese Application No. 201310203191.7 filed May 28, 2014, the entire content of which is hereby incorporated by reference.

### FIELD OF THE INVENTION

The present disclosure relates to isolation of apparatus, and more specifically, to an apparatus with a closed housing, as well as isolation and manufacture method thereof.

### BACKGROUND OF THE INVENTION

In the applications such as waterscreen film, waterscreen laser show, digital water curtain and the like, lighting device or other devices which operate under water are usually necessary. Such devices under water are usually arranged in an isolation apparatus with a closed housing so as to isolate the devices from the water environment surrounding them. However, due to manufacturing error of the housing and the like, it is usually difficult to totally isolate the inside of the isolation apparatus from the water environment only by means of the housing, or it is usually highly expensive to sufficiently isolate the inside of the isolation apparatus from the water environment.

Once the water gets into the housing, the performance and/or lifetime of the devices, such as lighting devices, contained in the isolation apparatus will be adversely influenced.

Besides, even if the inside of the isolation apparatus is sufficiently isolated from the water environment in an expensive manner, it is usually difficult to maintain or replace the isolation apparatus itself or the devices contained therein.

### SUMMARY OF THE INVENTION

Therefore, the present disclosure proposes an apparatus with a closed housing, as well as isolation and manufacture method thereof, in order to isolate the inside of the apparatus from a first medium outside the apparatus.

One aspect of the present invention is directed to an apparatus with a closed housing, wherein the apparatus is arranged in a first medium during operating, and the inside of the apparatus is filled with a second medium the pressure of which is higher than the pressure of the first medium.

The apparatus may comprise: a sensor configured to detect the pressure of the second medium; and a single way valve disposed on the closed housing configured such that when the pressure of the second medium detected by the sensor is lower than a predetermined threshold value, the pressure of the second medium is increased via the single way valve so as to keep the pressure of the second medium above the predetermined threshold value.

Likely, the apparatus may comprise: a sensor configured to detect the pressure of the second medium; and a valve disposed on the closed housing configured such that when the pressure of the second medium detected by the sensor is beyond a predetermined range, the pressure of the second medium is changed via the valve so as to keep the pressure of the second medium within the predetermined range.

In the apparatus, the first medium may be liquid, particularly water, and the second medium may be gas, particularly air.

A lighting device, particularly an LED, may be contained in the apparatus, and a light outlet may be provided on the closed housing. Such apparatus may be used for lighting from the water.

Another aspect of the present invention is directed to a method for isolating the inside of an apparatus having a closed housing with a first medium outside the apparatus, comprising: filling the inside of the apparatus with a second medium such that the pressure of the second medium is higher than the pressure of the first medium.

The method may further comprise: detecting the pressure of the second medium; and increasing the pressure of the second medium so as to keep the pressure of the second medium above a predetermined threshold value, when the pressure of the second medium is lower than the predetermined threshold value.

Likely, the method may comprise: detecting the pressure of the second medium; and changing the pressure of the second medium so as to keep the pressure of the second medium within a predetermined range, when the pressure of the second medium is beyond the predetermined range.

In the method, the first medium may be liquid, particularly water, and the second medium may be gas, particularly air.

In the method, a lighting apparatus, particularly an LED, may be received in the apparatus, and a light outlet may be provided on the closed housing.

Another aspect of the present invention is directed to a method for manufacturing the apparatus described above, comprising: providing a valve on the closed housing for changing the pressure of the second medium inside the apparatus. The valve may be a single way valve.

By means of the apparatus with the closed housing and the isolation and manufacture method according to the aspects of the present invention, at least one of the following objects may be achieved: achieving sufficient sealing with relatively low cost, improving the performance and/or lifetime of the devices contained in the apparatus, and facilitate the maintaining and replacing of the apparatus and the devices contained therein.

These and other advantages will become more obvious hereinafter by means of the detailed illustration of the preferred embodiment of the invention in conjunction with drawings.

### BRIEF DESCRIPTION OF THE DRAWINGS

The present disclosure will be better understood with reference to the following description given in conjunction with the drawings. In the drawings, the same or similar reference numerals indicate the same or similar components. The drawings and the following detailed description are included in the specification to form a part of the specification, and are used to further illustrate the preferred embodiments of the invention by means of some examples and explain the principles and advantages of the invention. In the drawings:

FIG. 1 is an illustrative diagram showing some components of an apparatus with a closed housing according to an embodiment of the present disclosure;

FIG. 2 is an illustrative diagram showing the apparatus with the closed housing according to the embodiment of the present disclosure; and

FIG. 3 is an illustrative diagram showing the sensor and valve included in the apparatus with the closed housing according to the embodiment of the present disclosure.

### DETAILED DESCRIPTION OF THE DRAWINGS

The exemplary embodiments of the present disclosure are described hereinafter in conjunction with the drawings. For the sake of conciseness and clarity, not all the features of the actual embodiments are described in the specification.

Herein, description of the embodiments of the present disclosure will be made by taking the apparatus 100 with a closed housing and containing a lighting device as an example.

Those ordinary skilled in the art should understand, the device contained in the apparatus 100 may be any type of device other than lighting device.

The apparatus 100 is arranged in the water when operating, and the inside of the apparatus 100 is filled with air the pressure of which is higher the pressure of water.

Those ordinary skilled in the art should understand, the apparatus 100 may be arranged in other proper liquid, such as oil and the like, when operating, and may also be arranged in medium other than liquid, such as gas which is corrosive to the device contained in the apparatus 100, when operating. Besides, the inside of the apparatus 100 may be filled with gas other than air, such as nitrogen or inert gas, and may also be filled with medium other than gas, such as liquid which is advantageous to, or at least not disadvantageous to, the device contained in the apparatus 100.

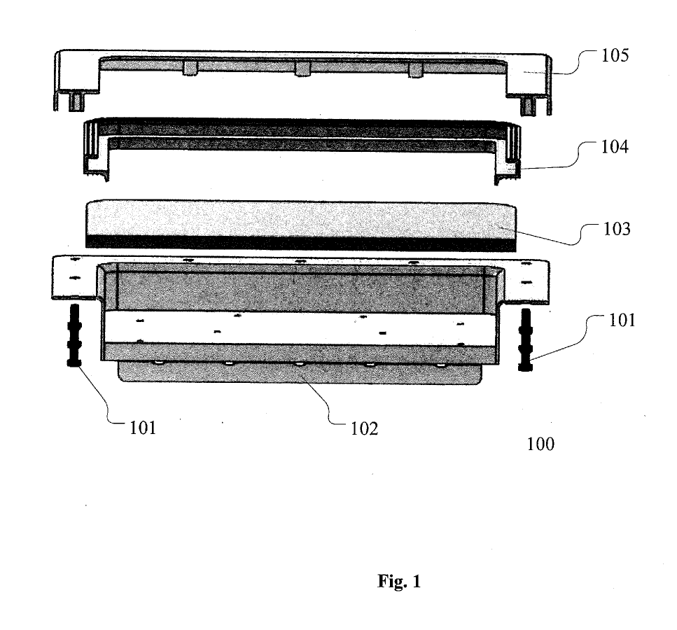

FIG. 1 is an illustrative diagram showing some components of the apparatus 100.

In FIG. 1, the apparatus 100 mainly includes screws 101, a housing bottom 102, a glass plate 103, a glass sealing 104 and a housing top 105. It should be noted that, for the convenience of showing the structure of the apparatus 100, the sections of the components are illustratively shown in FIG. 1.

Although only two screws 101 are shown in FIG. 1, in fact, the amount of the screws 101 are not limited thereto. The housing bottom 102 and the housing top 105 are fixed together by means of the screws 101, and the glass plate 103 is positioned between the housing bottom 102 and the housing top 105 by means of the glass sealing 104. The more detailed relationships of amounting among the screws 101, the housing bottom 102, the glass plate 103, the glass sealing 104 and the housing top 105 are not the points of the present disclosure, and will not be described in detail herein.

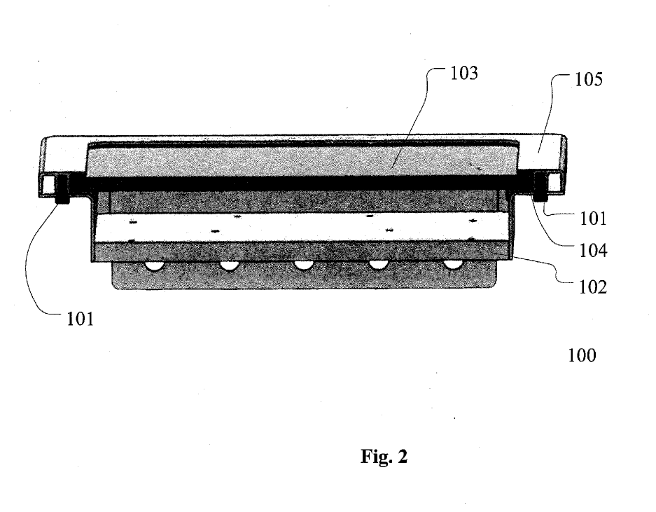

The assembled apparatus 100 is shown in FIG. 2. It should be noted that, for the convenience of showing the structure of the apparatus 100, the sections of the components are also illustratively shown in FIG. 2.

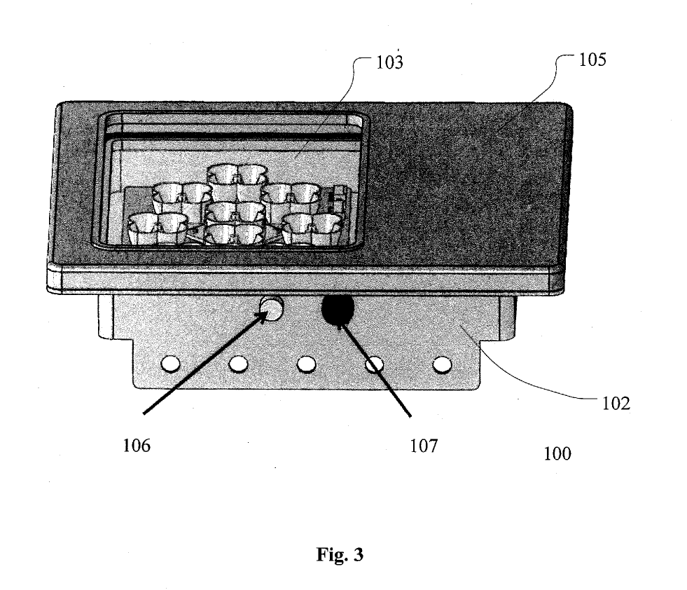

FIG. 3 shows the apparatus 100 and the lighting device contained therein. In FIG. 3, the glass plate 103 serves as a light outlet. Those ordinary skilled in the art should understand, when the apparatus 100 contains a lighting device, the light outlet may be provided in other manners. For example, the housing bottom 102 and the housing top 105 may be made of transparent material and serve as a light outlet.

Besides, it should be noted that, the lighting device shown in FIG. 3 is a plurality of LEDs. Those ordinary skilled in the art should understand, the lighting device may be single or multiple lighting device of any proper type.

Due to the structure of the apparatus 100 as shown in FIGS. 1 and 2, the space for containing the lighting device may be isolated with the outside of the apparatus 100. However, due to the existence of manufacturing error and the like, it is usually difficult to totally isolate the inside of the apparatus 100 with the water environment only by means of above structure, or it is usually highly expensive, for example, by extremely high machining precision, to sufficiently isolate the inside of the apparatus 100 from the water environment.

For example, the apparatus 100 containing the lighting device and used for lighting from the water may be the size of 32 cm×32 cm, and it is difficult to manufacture the housing bottom 102 and the housing top 105 with such a size to be totally flat by the existing process. Besides, the housing bottom 102 and the housing top 105 may become deformed during transportation. Furthermore, the change of temperature will also influence the sealing among the housing bottom 102, the glass plate 103, the glass sealing 104 and the housing top 105 which are usually made of different material.

According to the embodiment of the present disclosure, the inside of the apparatus 100 may be filled with a medium such as air, and the pressure of the air inside the apparatus 100 is higher than the pressure of water wherein the apparatus 100 is arranged when operating. By means of such configuration, even if totally isolation of the inside of the apparatus 100 with the water environment cannot be achieved by the structure shown in FIGS. 1 and 2, the water outside the apparatus 100 is still not able to get into the inside of the apparatus 100 due to the pressure of air. Therefore, it is possible to prevent the performance and/or lifetime of the device contained in the apparatus 100 from being influenced by the inducing of water or by the increasing of humidity caused by the inducing of water. Meanwhile, since the apparatus 100 does not have any complex structure, it will be easy to maintain or replace the apparatus 100 itself or the device inside the apparatus 100.

Since the pressure within the apparatus 100 may change, for example, the air inside the apparatus 100 may slowly leaks into the water outside the apparatus 100 due to the imperfect isolation of the inside of the apparatus 100 with the water environment, the apparatus may include a sensor 106 and a valve 107 as shown in FIG. 3 in order to keep the pressure of the air inside the apparatus 100 within a predetermined range. FIG. 3 shows the sensor 106 and the valve 107 of the apparatus 100.

The sensor 106 detects the pressure of the air inside the apparatus 100. The sensor 106 may be a digital or analog gas gauge, and may also be any other type of means suitable for detecting the pressure of the air inside the apparatus 100. Besides, when the medium inside the apparatus 100 is the medium other than air, the sensor 106 may be corresponding type of means for detecting the pressure of such medium.

Although FIG. 3 shows that the sensor 106 is located on the housing bottom 102, the sensor 106 may be located at any proper position.

The valve 107 is located on the housing bottom 102, but the embodiment of the present disclosure is not limited thereto, and the valve 107 may be located on the housing top 105 or the glass plate 103, as long as the valve 107 is located on the closed housing of the apparatus 100.

When the sensor 106 detects that the pressure of the air goes beyond the predetermined range, the pressure of the air may be changed via the valve 107 by an execution device (not shown), such that the pressure of the air is kept within the predetermined range.

The execution device may be any device suitable for changing the pressure of the air, such as a pump. When the medium inside the apparatus 100 is the medium other than air, the execution device may be corresponding type of means for changing the pressure of such medium. Besides, the execution device may be either a separated device outside the apparatus 100, or a component of the apparatus 100.

The communication between the sensor 106 and the execution device may be performed by means of remote control such as RDM (Remote Device Management)/DMX (Digital Multiplex). In the application scene of lighting from water, the RDM/DMX remote control may also be used for control the lighting device, particularly an LED, contained in the apparatus 100.

Specifically, in the case that the lighting device is an LED, the lighting device may further have RDM/DMX receiver for receiving signals from an RDM/DMX controller, a circuit for diming via the RDM/DMX controller, a circuit for LED over-heat protection, a circuit for LED temperature monitor, a circuit for output short-circuit protection, a circuit for providing constant current for each LED and the like.

In a specific application, the lighting device may have the specification as following: 20-30 DC power input, 8 bit PWM precision for each channel, 1.4 A constant current for each LED which could go up to 2 A if necessary.

Since the configuration of the lighting device is not the point of the present disclosure, for the sake of simplicity, the detailed description thereof will not be made herein.

Those ordinary skilled in the art should understand, the communication between the sensor 106 and the execution device may also be performed in any other proper manner.

Usually, the pressure of the air inside the apparatus 100 only needs to higher than a predetermined threshold value. At this time, the valve 107 may be a single way valve 107. When the pressure of the air detected by the sensor 106 is lower than the predetermined threshold value, the execution device increases the pressure of the air via the single way valve 107.

In some application scene, it is also possible to require the pressure of the air inside the apparatus 100 to be below a predetermined upper limit. At this time, another single way valve (not shown) may be provided. When the pressure of the air detected by the sensor 106 is higher than the predetermined upper limit, the execution device decreases the pressure of the air via the other single way valve.

Besides, in the case that the pressure of the air inside the apparatus 100 is required to be below a predetermined upper limit, the valve 107 may be configured as a two way valve. When the pressure of the air detected by the sensor 106 is lower than the predetermined threshold value, the execution device increases the pressure of the air via the two way valve, and when the pressure of the air detected by the sensor 106 is higher than the predetermined upper limit, the execution device decreases the pressure of the air via the two way valve.

Based on the above, according to the embodiment of the present disclosure, it is also provided a method for manufacturing the apparatus 100, wherein, a valve for changing the pressure of the air inside the apparatus 100 is provided on the closed housing of the apparatus 100. The valve may be a single way valve.

The terms “include”, “comprise” and any other variants of them are inclusive, and do not exclude additional, unrecited elements of a process, method, product, apparatus or device, as well as those elements that are inherently included by the process, method, product, apparatus or device. Without further limitations, the wording “including an” element does not exclude the possibility of the same elements present in the process, method, product, apparatus or device including the element.

The embodiments of the present disclosure are described in detail in conjunction with the accompanying drawings. However, those with ordinary skill in the art will appreciate that the embodiments described above are for illustrative purposes only and shall not be interpreted as limiting the present disclosure. Those with ordinary skill in the art will also appreciate that various modifications, equivalents and variations may be made without deviation from the spirit and scope of the present disclosure defined by the claims attached. Therefore, the scope of the present disclosure shall be defined by only the claims attached and their equivalents.

Moreover, the scope of the present disclosure is not limited to the specific embodiments of the processes, methods, apparatuses and devices described herein. Those skilled in the art will appreciate that, based on the present utility model, the process, method, apparatus or device according to the present disclosure may use those elements, either existing or to be developed in the future, that carry out functions or can lead to results substantially the same as the elements disclosed in the embodiments herein. Therefore, the attached claims shall include the process, method, apparatus or device including such elements.

1. An apparatus with a closed housing, wherein the apparatus is arranged in a first medium during operating, and the inside of the apparatus is filled with a second medium the pressure of which is higher than the pressure of the first medium.

2. The apparatus according to claim 1, comprising:
a sensor configured to detect the pressure of the second medium; and
a single way valve disposed on the closed housing configured such that when the pressure of the second medium detected by the sensor is lower than a predetermined threshold value, the pressure of the second medium is increased via the single way valve so as to keep the pressure of the second medium above the predetermined threshold value.

3. The apparatus according to claim 1, comprising:
a sensor configured to detect the pressure of the second medium; and
a valve disposed on the closed housing configured such that when the pressure of the second medium detected by the sensor is beyond a predetermined range, the pressure of the second medium is changed via the valve so as to keep the pressure of the second medium within the predetermined range.

4. The apparatus according to claim 1, wherein:
the first medium is liquid and the second medium is gas.

5. The apparatus according to claim 4, wherein:
the liquid is water and the gas is air.

6. The apparatus according to claim 1, wherein:
a lighting device is received in the apparatus, and
a light outlet is provided on the closed housing.

7. The apparatus according to claim 6, wherein:
the lighting device is an LED.

8. A method for isolating the inside of an apparatus having a closed housing with a first medium outside the apparatus, comprising:
filling the inside of the apparatus with a second medium such that the pressure of the second medium is higher than the pressure of the first medium.

9. The method according to claim 8, further comprising:
detecting the pressure of the second medium; and
increasing the pressure of the second medium so as to keep the pressure of the second medium above a predetermined threshold value, when the pressure of the second medium is lower than the predetermined threshold value.

10. The method according to claim 8, further comprising:
detecting the pressure of the second medium; and
changing the pressure of the second medium so as to keep the pressure of the second medium within a predetermined range, when the pressure of the second medium is beyond the predetermined range.

11. The method according to claim 8, wherein:
the first medium is liquid and the second medium is gas.

12. The method according to claim 11, wherein:
the liquid is water and the gas is air.

13. The method according to claim 8, wherein:
a lighting apparatus is received in the apparatus, and
a light outlet is provided on the closed housing.

14. The method according to claim 13, wherein:
the lighting apparatus is an LED.

15. A method for manufacturing the apparatus according to claim 1, comprising:
providing a valve on the closed housing for changing the pressure of the second medium inside the apparatus.

16. The method according to claim 15, wherein:
the valve is a single way valve.
